(19) United States
(12) Patent Application Publication
(10) Pub. No.: US 2003/0216153 A1
(43) Pub. Date: Nov. 20, 2003

(54) Wireless base station enclosure

(76) Inventor: Igor Golioto, Fairfield, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/146,581

(22) Filed: May 15, 2002

(51) Int. Cl. H04M 1/00

(52) U.S. Cl. 455/561

(57) ABSTRACT

A wireless base station enclosure. The wireless base station enclosure houses at least one circuit board for generating heat by means of an inner housing and an outer sheath. The inner housing protects the circuit board from environmental conditions and may be formed from a polymer-based plastic and have a blow molded shape. The outer sheath protects the circuit board from impact conditions and may comprise metal, alloy or a composite material. The wireless base station enclosure also includes a passive cooling system for convection cooling the enclosure. The convection cooling system has an air induction gap formed between the outer sheath and the inner housing, as well as one or more holes in the outer sheath to enable heat within the air induction gap to escape.

### BACKGROUND OF THE INVENTION

I. Field of the Invention

The present invention generally relates to wireless base stations, and more particularly, a cabinet for withstanding rugged environmental and impact conditions.

II. Description of the Related Art

The proliferation of wireless communication systems has led to an increase in the number of base stations deployed. Each base station may be enclosed in a cabinet for housing sensitive electronics equipment. These cabinets provide a barrier for protecting the sensitive electronics equipment from environmental conditions, such as moisture, dirt, ultra violet radiation, for example as well as impact conditions, such as earthquakes and shipping, for example.

To date, cabinets have been constructed using various known methods. Each of these techniques provides the cabinet with a sufficient barrier against environmental and impact conditions. In 2G systems, cabinets have been designed to comprise a metal housing for its rigidity to provide impact resistance for the sensitive electronics equipment. The metal seams of the housing exterior are welded together to prevent seepage of moisture into the interior and seal out the elements where the sensitive electronics equipment resides. A primary cooling system, such as an air-to-air heat exchange was also incorporate to cool the sensitive electronics equipment. It has been estimated that at least one-third (⅓) of the resources expended by the air-to-air heat exchange are designed to address energy attributable to solar loading—i.e., the heating of the cabinet by the sun. The remaining two-thirds (⅔) of the resources expended by the air-to-air heat exchange is allocated for maintaining the sensitive electronics equipment at sufficient low operating temperature.

Welding together the seams of the metal housing exterior, however, has become cost prohibitive. Presently, welding the seams of a metal housing may run upwards of $2500 for a 72″ high by 32″ wide by 24″ deep cabinet, or, in other words, $1.50 per inch, given present skilled labor and material costs. As a result, 3G cabinet designs presently being deployed have begun to explore alternatives for protecting the sensitive electronics equipment from environmental and impact conditions. One such alternative incorporated a labyrinth design. Here, the vertical seams of the metal housing exterior are mechanically enjoined using folded joints. These folded metal joints are further caulked and sealed to prevent seepage of moisture into the interior and seal out the elements where the sensitive electronics equipment resides. This labyrinth design also incorporates a primary cooling system, such as an air-to-air heat exchange, for cooling the sensitive electronics equipment, with roughly at least one-third (⅓) of the resources expended designed to address to solar loading, and the remaining resources allocated for maintaining the sensitive electronics equipment at sufficient low operating temperature. Presently, a labyrinth design for a 72″ high by 24″ wide by 24″ deep cabinet may cost upwards of $1750, given current skilled labor and material costs. While considerably cheaper than the welded cabinet approach employed in 2G designs, this labyrinth implementation is still relatively expensive and inefficient in allocating at least one-third of its air-to-air heat exchange for solar loading.

Consequently, a need exists for a base station cabinet and the like, which is relatively inexpensive. Moreover, a demand exists for a base station cabinet that more efficiently utilizes its air-to-air heat exchange such that an increasing amount of sensitive electronics equipment may be deployed within each cabinet, or, alternatively, the size of each cabinet may be reduced.

### SUMMARY OF THE INVENTION

The present invention provides for a relatively inexpensive base station cabinet, enabling the more efficiently utilization of a primary active cooling system, such as an air-to-air heat exchange system. The present invention employs a polymer-based plastic inner housing for protecting the sensitive electronics equipment therein from environmental conditions, such as moisture, dirt, and ultra violet radiation, for example. The base station cabinet may also incorporate a metal sheath exterior housing to provide impact resistance for the sensitive electronics equipment therein, given its greater rigidity than the polymer-plastic inner housing.

In one embodiment of the present invention, the base station cabinet has a polymer-based plastic inner housing for protecting sensitive electronics equipment from environmental conditions. The polymer-based plastic inner housing may be blow-molded polyethylene, for example, to form an at least four-sided structure to encompass the sensitive electronics equipment. A metal sheath exterior housing is incorporated outside the polymer-based plastic inner housing to provide outdoor ruggedness, such as impact resistance. The metal sheath exterior housing may be spaced from the polymer-based plastic inner housing to provide an air induction gap and create a convection cooling system. Heat emanating from the polymer-based plastic inner housing, consequently, may escape outside the cabinet through one or more vents or holes formed within metal sheath exterior housing. Moreover, one or more vents or holes may also be formed in a portion of the polymer-based plastic inner housing insensitive to environmental conditions to thereby allow heat emanating from the sensitive electronics equipment to escape outside the cabinet through one or more vents or holes formed within metal sheath exterior housing. The polymer-based plastic inner housing further provides insulation to protect the polymer-based plastic inner housing from solar loading.

### BRIEF DESCRIPTION OF THE DRAWINGS

The present invention will be better understood from reading the following description of non-limiting embodiments, with reference to the attached drawings, wherein below:

FIG. 1 depicts a cross-sectional view of an embodiment of the present invention;

FIG. 2 depicts a perspective view of another embodiment of the present invention; and

FIG. 3 depicts a perspective view of another embodiment of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

The present invention addresses the need for protecting the sensitive electronics equipment stored in an enclosure, such as a base station cabinet, for example, from environmental conditions in a relatively inexpensive manner. The enclosure comprises an inner housing for protecting at least one circuit board from environmental conditions. The enclosure may also comprise a convection cooling system for cooling the sensitive electronics equipment. Consequently, the demands on a primary cooling system, such as an air-to-air heat exchange system, for example, may be reduced.

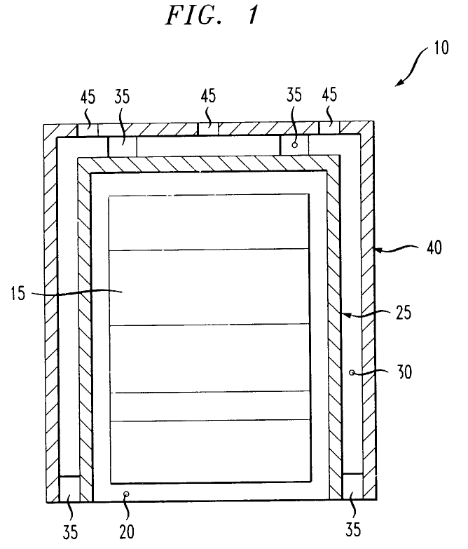

Referring to FIG. 1, a cross-sectional view of a base station enclosure 10 according to an embodiment of the present invention is illustrated. Enclosure 10 comprises sensitive electronics equipment 15. Electronics equipment 15 may include various different hardware components, including one or more circuit boards. Electronics equipment 15 is stored within enclosure 10 on a support rail structure 20.

Enclosure 10 comprises a first or inner housing 25. Inner housing 25 protects electronics equipment 15 from environmental conditions, such as moisture, dirt, and ultra violet radiation, for example. Inner housing 25 may comprise a various polymer-based plastic materials, such as polyethylene, for example. The polymer-based plastic material(s) selected for use in fabricating inner housing 25 should provide moisture resistance, greater insulating characteristics than conductive metals, such as aluminum or steel, as well as provide ultra violet resistance. Moreover, the polymer-based plastic material(s) selected for use in fabricating inner housing 25 should also be able to withstand a temperature range between −40° C. to +55° C. without materials expansion or contraction issues.

Inner housing 25 may conformally fit over electronics equipment 15 and support rail structure 20. To encompass electronics equipment 15 and support rail structure 20 in a conformal manner, polymer-based plastic inner housing 25 may be formed by blow-molding and/or injection-molding process step(s). It should be noted that other methods of manufacturing inner housing 25 will be apparent to skilled artisans upon reviewing the instant disclosure. Using a blow-molded technique, an inner housing 25 formed from polyethylene having dimensions of a 72″ high by 24″ wide by 24″ deep has been estimated, given present skilled labor and material costs, to be no greater than $750.

Enclosure 10 also comprises a second or outer housing 40. Outer housing or sheath 40 protects electronics equipment 15 from impact conditions, such as extreme motion, including earthquakes, shipping and handling, as well as sufficiency for passing a shotgun test, for example, by providing increased rigidity over inner housing 25. These outdoor ruggedness characteristics may be realized by using a metal, alloy and/or composite to fabricate outer housing 40. In one embodiment of the present invention, outer housing 40 comprises aluminum or steel.

As shown, an air gap 30 is formed between outer housing 40 and from inner housing 25. Air induction gap 30 is created by using standoffs 35. Standoffs 35 are positioned and physically couple to the outer surface(s) of inner housing 25 and the inner surfaces of outer housing 40. Relying on through one or more holes or vents 45 in outer housing 40 in conjunction with air induction gap 30, a convection cooling system is created. It should be noted that the material selection of inner housing 25 provides insulation of electronics equipment 15 from solar loading. The convection cooling system allows heat within the air induction gap to pass through vents 45 into the ambient environment. In another embodiment, the convection cooling system allows heat generated by electronics equipment 15 to pass from the air induction gap through vents 45 without compromising electronics equipment 15 to environmental conditions by means of one or more vents (not shown) in inner housing 25 positioned in locations insensitive to the environmental conditions. By incorporating this passive convection cooling system, the demands on a primary cooling system, such as an air-to-air heat exchange system, that might be incorporated within or used in conjunction with enclosure 10 are noticeably reduced.

In one embodiment of the present invention, the passive convection cooling system created by air induction gap 30 and vents 45 reduces the resources needed by an air-to-air heat exchange system for solar loading. As a result of employing the passive convection cooling system, less than one-third (⅓) of the air-to-air heat exchange system's may be required for solar loading. Consequently, a greater amount of the air-to-air heat exchange system's resources may be allocated to cooling electronics equipment 15, resulting in either smaller dimensional requirements for enclosure 10 or a larger number of electronics equipment 15 (e.g., more circuit boards), corresponding with a more powerful wireless base station unit.

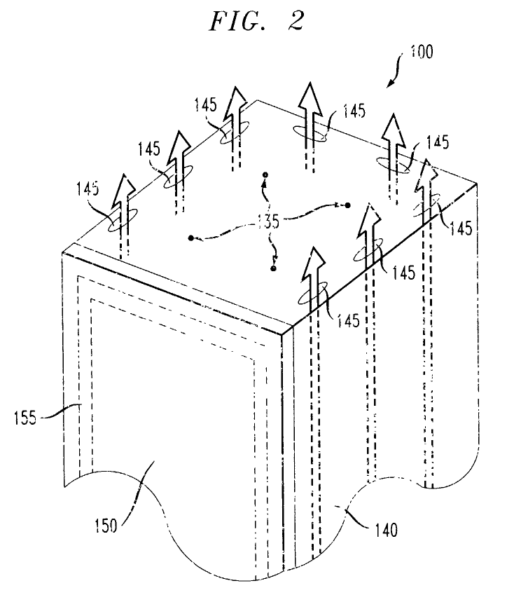

Referring to FIG. 2, a perspective view of another embodiment of a base station enclosure 100 according to another embodiment of the present invention is illustrated. Enclosure 100 comprises an outer sheath or housing 140 having a number of vents 145 created by standoffs 135. Vents 145 allow heat generated from the electronics equipment to pass therethrough by means of the aforementioned passive convection cooling system. Outer housing 140 comprises a door 150 to provide access to electronics equipment (not shown) within enclosure 100. A seal 155 is included to protect the electronics equipment from the environmental conditions. By this arrangement, a polymer-based plastic inner housing (not shown) may comprises a four-sided structure and the support structure of door 150 and seal 155 attached to a fifth side.

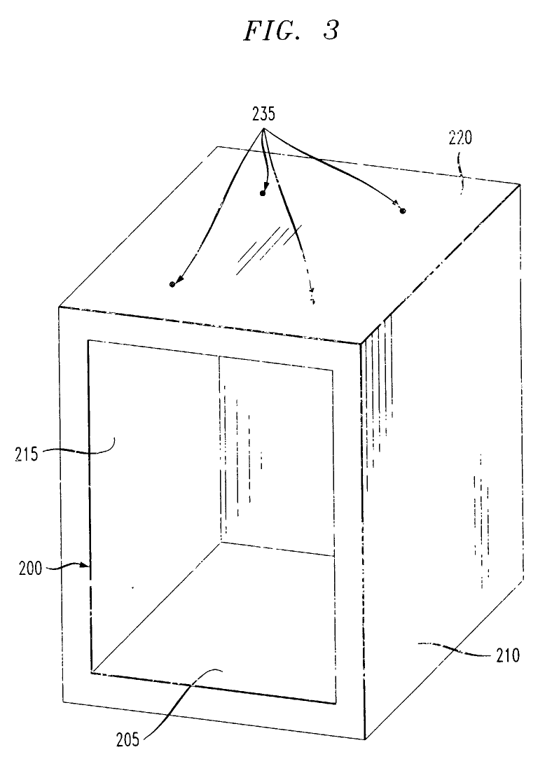

Referring to FIG. 3, a perspective view of another embodiment of the present invention is illustrated. Here, a polymer-based plastic inner housing 200 is shown having a first, second, third and fourth side, 205, 210 215 and 220. Inner housing 200 is shown as having lift points 235 for receiving a number of standoffs to create the aforementioned air induction gap.

Inner housing 200 also comprises a first and second open-ended face. The first open-ended is incorporated to allow a door on an outer housing (not shown) to access the electronics equipment stored within the enclosure. The second open-ended face may be employed to allow an open bottom for the enclosure of the wireless base station. It should be apparent to skilled artisans that the enclosure for which inner housing 200 is designed may only require one open face, serving both as access path from the outer housing, as well as an open bottom for the enclosure.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

1. An enclosure comprising:
a polymer-based plastic first housing for protecting at least one circuit board from environmental conditions; and
a second housing for protecting the at least one circuit board from impact conditions, the second housing spaced from the first housing to create an air induction gap for enabling passive cooling of the at least one circuit board.

2. The enclosure of claim 1, wherein the second housing comprises at least one hole to allow heat in the air induction gap to transfer to ambient air.

3. The enclosure of claim 2, wherein the first housing provides insulation from solar loading, and further comprising:
an active cooling system for cooling the at least one circuit board by transferring heat to ambient air.

4. The enclosure of claim 2, wherein the polymer-based plastic first housing comprises a blow molded shape.

5. The enclosure of claim 2, wherein the polymer-based plastic first housing is at least one of moisture resistant and ultra violet radiation resistant.

6. The enclosure of claim 2, wherein the polymer-based plastic first housing comprises polyethylene.

7. The enclosure of claim 2, wherein the second housing comprises at least one of a metal, alloy and composite.

8. The enclosure of claim 5, wherein the polymer-based plastic first housing comprises at least a four-sided sleeve having a fifth side comprising a door and support attached thereto.

9. A wireless base station enclosure comprising:
at least one circuit board;
a polymer-based plastic inner housing for protecting the at least one circuit board from environmental conditions;
an outer housing for protecting the at least one circuit board from impact conditions; and
a convection cooling system for passively cooling the at least one circuit board, the convection cooling system comprising:
an air induction gap formed between the outer housing and the inner housing; and
at least one hole in the outer housing for enabling heat within the air induction gap to escape therethrough.

10. The enclosure of claim 9, wherein the first housing provides insulation from solar loading, and further comprising an air-to-air heat exchange system for transferring heat from the at least one circuit board to ambient air.

11. The enclosure of claim 9, wherein the polymer-based plastic inner housing comprises a blow molded shape.

12. The enclosure of claim 9, wherein the polymer-based plastic inner housing is at least one of moisture resistant and ultra violet radiation resistant.

13. The enclosure of claim 9, wherein the polymer-based plastic inner housing comprises polyethylene.

14. The enclosure of claim 9, wherein the outer housing comprises at least one of a metal, alloy and composite.

15. The enclosure of claim 9, wherein the polymer-based plastic inner housing comprises at least a four-sided sleeve having a fifth side comprising a maintenance door and support attached thereto.

16. A wireless base station enclosure comprising:
at least one circuit board;
an inner housing for protecting the at least one circuit board from environmental conditions, the inner housing comprising polymer-based plastic having a blow molded shape;
an outer sheath for protecting the at least one circuit board from impact conditions, the outer sheath comprising at least one of a metal, alloy and composite; and
a convection cooling system for convection cooling the at least one circuit board, the convection cooling system comprising:
an air induction gap formed between the outer sheath and the inner housing; and
at least one hole in the outer sheath for enabling heat within the air induction gap to escape therethrough.

17. The enclosure of claim 16, wherein the first housing provides insulation from solar loading, and further comprising an air-to-air heat exchange system for transferring heat from the at least one circuit board to ambient air.

18. The enclosure of claim 16, wherein the polymer-based plastic inner housing is at least one of moisture resistant and ultra violet radiation resistant.

19. The enclosure of claim 16, wherein the polymer-based plastic inner housing comprises at least a four-sided sleeve having a fifth side comprising a maintenance door and support attached thereto.
